(19) United States
(12) Patent Application Publication
(10) Pub. No.: US 2009/0125364 A1
(43) Pub. Date: May 14, 2009

(54) FRAMEWORK FOR ACHIEVING A REWARDING RELATIONSHIP

(76) Inventor: JAYANTH MYSORE POORNA, Bangalore (IN)

Correspondence Address: Global IP Services, PLLC, 198 F, 27th Cross, 3rd Block, Jayanagar, Bangalore, Karnataka, 560011, IN

(21) Appl. No.: 11/937,500

(22) Filed: Nov. 9, 2007

(51) Int. Cl. G06Q 10/00

(52) U.S. Cl. 705/9; 705/11

(57) ABSTRACT

A framework for achieving a rewarding relationship is disclosed. In one embodiment, a method includes generating a customer service hierarchy including customer service levels, each customer service level having associated demands, determining if the demands of an initial customer service level in the customer service hierarchy are met, upon a determination that the demands of the initial customer service level are met, determining if the demands of the initial customer service level are exceeded, and for each successor customer service level in the customer service hierarchy, determining if the demands of a predecessor customer service level in the customer service hierarchy continue to be exceeded, upon a determination that the demands of the predecessor customer service level continue to be exceeded, determining if the demands of a successor customer service level in the customer service hierarchy are met.

### FIELD OF THE INVENTION

The present invention relates generally to hardware and software and more particularly relates to relationship methodologies and techniques.

### BACKGROUND

A relationship between entities may be deemed satisfactory. On the other hand, the relationship may be deemed less than satisfactory. The entities may seek ways to improve the relationship and to achieve a rewarding relationship. The ways to improve, however, may be difficult to determine or may be difficult to implement.

To illustrate, a customer service organization may provide various customer services to a variety of customers. The customer service organization, however, may face intense competition from other providers.

Further, the customer service organization may not be able to differentiate its services from those of the other providers. For example, the customer service organization may not be able to articulate a distinct value proposition for potential customers. As a result, the customer service organization may not be able to attract or retain customers.

In addition, the customer may have an increased expectation for the customer service organization to act as the customer's business partner. Thus, the customer service organization may be expected to provide levels and varieties of services that it cannot deliver.

### BRIEF DESCRIPTION OF THE DRAWINGS

Example embodiments are illustrated by way of example and not limitation in the figures of the accompanying drawings, in which like references indicate similar elements and in which:

FIG. 1 illustrates a customer service environment structured to meet demands of a customer through a hierarchy of customer service levels, according to one embodiment.

FIG. 2 is an illustrative representation of the customer service model, according to one embodiment.

FIG. 3 is a block diagram illustrating the customer service environment, according to one embodiment.

FIG. 4 is a flow diagram of the customer service module of FIG. 3, according to one embodiment.

FIG. 5 illustrates additional modules associated with the improvement level module of FIG. 4, according to one embodiment.

FIG. 6 illustrates a simplified flow chart representing a list of identified activities associated with the customer service, according to one embodiment.

FIG. 7 is a block diagram illustrating a list of measurements that describe current states and project-improved states of each identified activities, according to one embodiment.

FIG. 8 is a block diagram illustrating a timebound action plan associated with the identified activities, according to one embodiment.

FIG. 9 is a diagrammatic system view of a data processing system in which any of the embodiments disclosed herein may be performed, according to one embodiment.

FIG. 10A is a process flow of generating a customer service hierarchy to achieve customer service excellence, according to one embodiment.

FIG. 10B is a continuation of the process flow of FIG. 10A, illustrating additional processes, according to one embodiment.

FIG. 10C is a continuation of the process flow of FIG. 10B, illustrating additional processes, according to one embodiment.

FIG. 11 is a process flow of determining a level of customer service associated with a service of a customer, according to one embodiment.

FIG. 12 is a process flow of generating a relationship hierarchy to achieve a rewarding relationship, according to one embodiment.

FIG. 13 is a table view illustrating demand to be met at various customer service levels in the customer service hierarchy, according to one embodiment.

Other features of the present embodiments will be apparent from the accompanying drawings and from the detailed description that follows.

### DETAILED DESCRIPTION

A framework for achieving customer service excellence is disclosed. In the following description, for purposes of explanation, numerous specific details are set forth in order to provide a thorough understanding of the various embodiments. It will be evident, however, to one skilled in the art that the various embodiments may be practiced without these specific details.

In the following description, the term “relationship” includes, but is not limited to, any relationship between two or more entities. An entity includes, but is not limited to, a person, a group of persons, a business, etc. To illustrate, a relationship may be a customer service relationship. The entities in the customer service relationship may include, for example, the customer service provider and the customer. One, skilled in the art will recognize that various examples of relationships set out in the description are illustrative only and not limiting in scope.

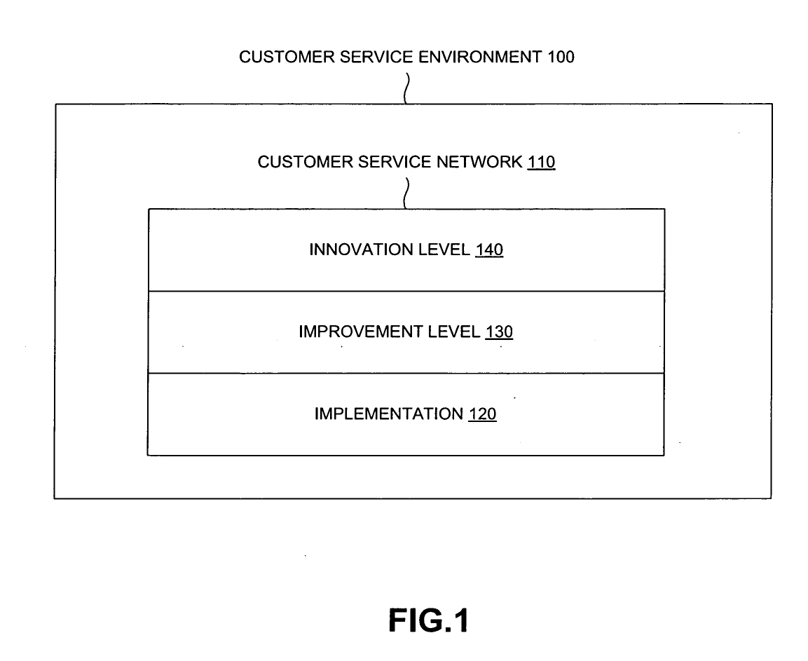

FIG. 1 illustrates a customer service environment 100 structured to meet demands of a customer through a hierarchy of customer service levels, according to one embodiment. Particularly, the customer service environment 100 illustrates a customer service network 110 with three hierarchical levels of customer service, an implementation level 120, an improvement level 130 and an innovation level 140, according to one embodiment.

The customer service network 110 may be an organizational network designed to satisfy needs and wants of the customer. In some embodiments, a customer service hierarchy, including customer service levels with associated demands is generated. In these embodiments, at each customer service level in the customer service hierarchy, distinct skills and attitudes are required to meet the demands of the customer.

For example, the customer service levels include the implementation level 120 that is an initial customer service level and the succeeding customer service levels namely the improvement level 130 and the innovation level 140. The implementation level 120 may include skills selected from the group including essentially of listening skills, hard work, attention to detail, and reliability. The improvement level 130 may include skills selected from the group including essentially of zero tolerance to mediocrity, positive restlessness, a desire to make things better, and sensitivity. The innovation level 140 may include skills selected from the group including essentially of sustained passion, conviction, creative thinking, lateral thinking, collaborative spirit, and a spirit of superior service.

In some embodiments, it is determined if the demands of the initial customer service level (i.e., the implementation level 120) in the customer service hierarchy are met. In these embodiments, it is determined if the demands of the initial customer service level 120 are exceeded upon a determination that the demands of the initial customer service level 120 are met. For each successor customer service level (i.e., the improvement level 130 and the innovation level 140) in the customer service hierarchy, it is determined if the demands of a predecessor customer service level in the customer service hierarchy continue to be exceeded.

Further, it is determined if the demands of a successor customer service level in the customer service hierarchy are met upon the determination that the demands of the predecessor customer service level continue to be exceeded. In one or more embodiments, it is ensured that the demands of the successor customer service level in the customer service hierarchy are exceeded to achieve superior customer service upon the determination that the demands of the successor customer service level are met.

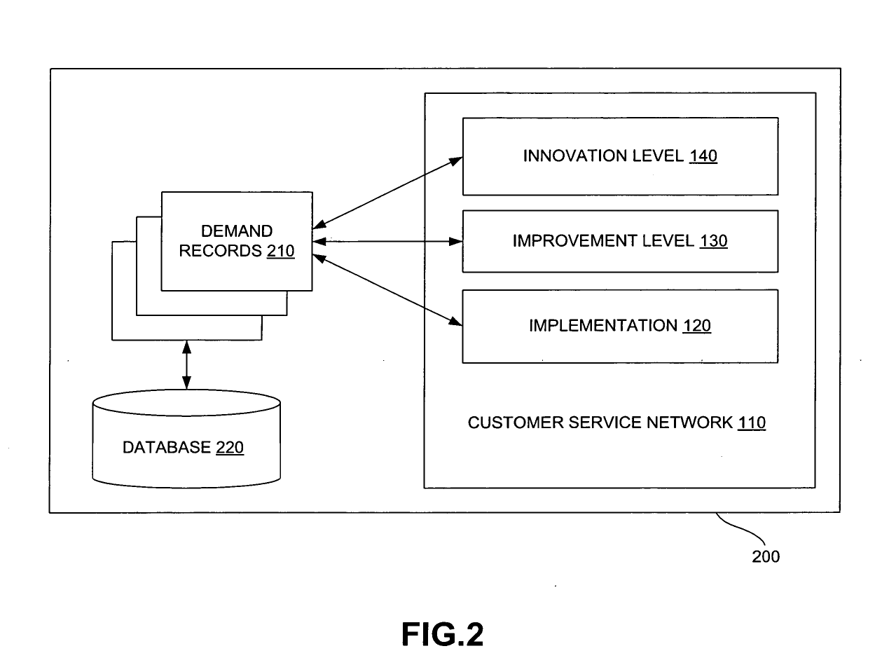

FIG. 2 is an illustrative representation of the customer service model 200, according to one embodiment. Particularly, FIG. 2 illustrates the implementation level 120, the improvement level 130 and the innovation level 140 associated with the customer service network 110, demand records 210 and a database 220, according to one embodiment.

The demand records 210 may include demands of customers to be met at various customer service levels in the customer service hierarchy. The database 220 may record the demands of the customers to be met at distinct customer service levels based on the skills and attitudes at each level. In one embodiment, the implementation level 120 may include generating a list of at least one experience associated with a moment of truth. For example, moments of truth occur when the customer experiences a customer service organization through any of the interfaces. For each experience associated with a moment of truth, at least one potential negative perception may be identified. Further, for each potential negative perception, a list of measures to be adopted to convert the potential negative perception into a potential positive perception may be generated.

In another embodiment, the improvement level 130 may include identifying key activities that have potential to significantly improve a customer's experience. For each key activity, a value proposition may be examined. Further, options may be evaluated based on each key activity and corresponding actions are executed. In yet another embodiment, the innovation level 140 may include creating visibility associated with the customer service. In some embodiments, innovation may be practiced in the customer service and subsequently a relationship with the customer associated with the customer service is built.

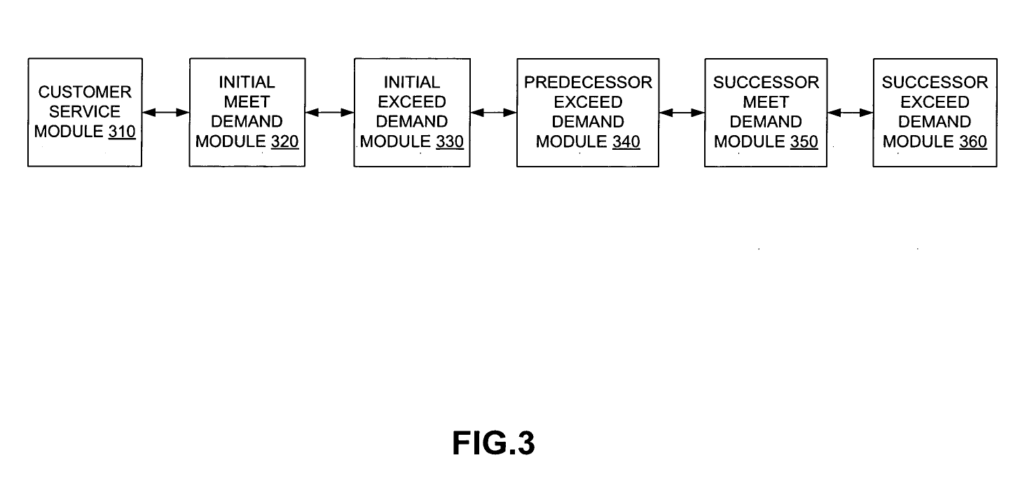

FIG. 3 is a block diagram illustrating the customer service environment 100, according to one embodiment. Particularly, FIG. 3 illustrates a customer service module 310, an initial meet demand module 320, an initial exceed demand module 330, a predecessor exceed demand module 340, a successor meet demand module 350 and a successor exceed demand module 360, according to one embodiment.

The customer service module 310 may generate a customer service hierarchy that includes customer service levels, where each customer service level has associated demands. The initial meet demand module 320 may determine if the demands of the initial customer service level (e.g., the implementation level 120 of FIG. 1) in the customer service hierarchy are met. The initial exceed demand module 330 may determine if the demands of the initial customer service level 120 are exceeded upon the determination that the demands of the initial customer service level 120 are met.

The predecessor exceed demand module 340 may determine if the demands of a predecessor customer service level (e.g., the implementation level 120 of FIG. 1) in the customer service hierarchy continue to be exceeded for each successor customer service level (e.g., the improvement level 130 and the innovation level 140 of FIG. 1) in the customer service hierarchy. The successor meet demand module 350 may determine if the demands of a successor customer service level 130 in the customer service hierarchy are met upon the determination that the demands of the predecessor customer service level 120 continue to be exceeded.

The successor exceed demand module 360 may ensure that the demands of the successor customer service level 130 in the customer service hierarchy are exceeded to provide superior customer service upon the determination that the demands of the successor customer service level 130 are met.

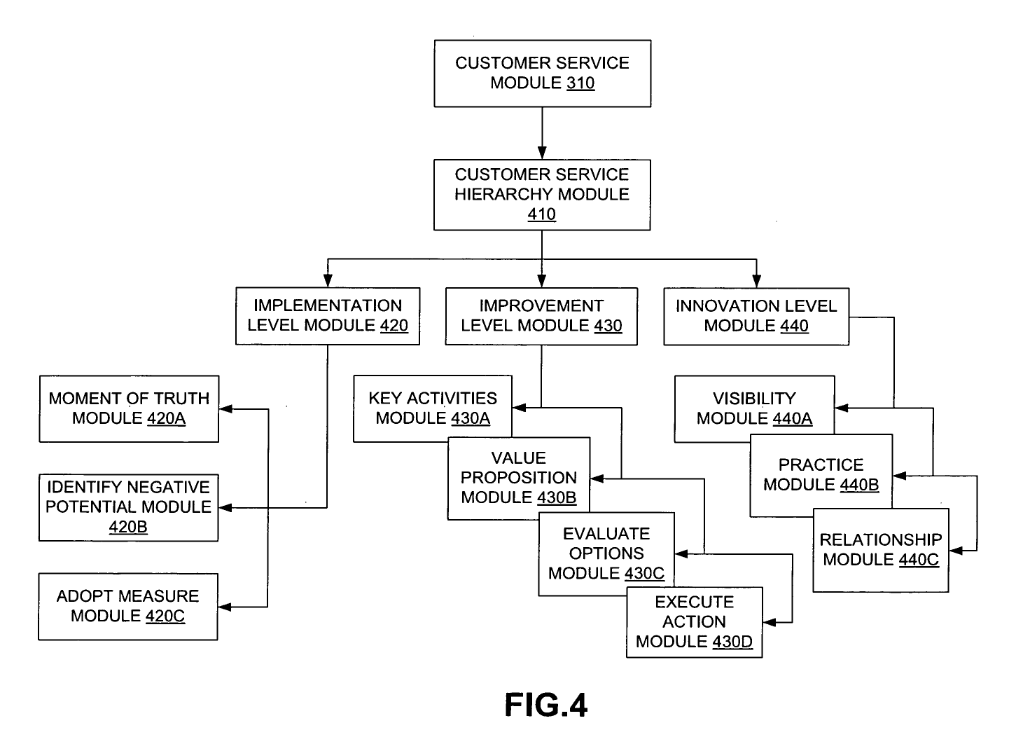

FIG. 4 is a flow diagram of the customer service module 310 of FIG. 3, according to one embodiment. Particularly, FIG. 4 illustrates a customer service hierarchy module 410, an implementation level module 420 that includes a moment of truth module 420A, an identify negative potential module 420B and an adopt measure module 420C, an improvement level module 430 that includes a key activities module 430A, a value proposition module 430B, an evaluate options module 430C and an execute action module 430D and an innovation level module 440 that includes a visibility module 440A, a practice module 440B and a relationship module 440C, according to one embodiment.

The customer service hierarchy module 410 may generate customer service levels to meet the demands of customers at various levels. For example, the customer service levels may include an implementation level 120, an improvement level 130 and an innovation level 140, each having distinct attitudes and skills. The implementation level module 420 may generate the implementation level 120 to implement a customer service. For example, customer service may be a series of activities designed to enhance the level of customer satisfaction—that is, the feeling that a product and/or service has met the customer expectation. The implementation level 120 may include skills selected from the group including essentially of listening skills, hard work, attention to detail, and reliability.

The moment of truth module 420A may generate a list of at least one experience associated with a moment of truth. For example, moments of truth occur when the customer experiences a customer service organization through any of the interfaces. Moments of truth can strongly influence an individual's decision to work with, or leave the organization. The identify negative potential module 420B may identify at least one potential negative perception for each experience. The adopt measure module 420C may generate for each potential negative perception, a list of measures to be adopted to convert the potential negative perception into a potential positive perception. The improvement level module 430 may generate the improvement level 130 to improve upon a customer's experience. The improvement level 130 may include skills selected from the group including essentially of zero tolerance to mediocrity, positive restlessness, a desire to make things better, and sensitivity.

The key activities module 430A may identify key activities that have potential to significantly improve the customer's experience. The value proposition module 430B may examine a value proposition for each key activity. For example, value proposition may be defined as what the customer gets for what the customer pays. The evaluate options module 430C may evaluate options for each value proposition associated with a key activity. The execute action module 430D may execute actions based on the evaluated options associated with the key activity.

The innovation level module 440 may generate the innovation level 140 to achieve superior customer service. The innovation level 140 may include skills selected from the group including essentially of sustained passion, conviction, creative thinking, lateral thinking, collaborative spirit, and a spirit of superior service. The visibility module 440A may create visibility associated with the customer service. The practice module 440B may practice innovation in the customer service. The relationship module 440C may build a relationship with a customer associated with the customer service. For example, goodwill, trust, loyalty, etc. may be required to begin the relationship.

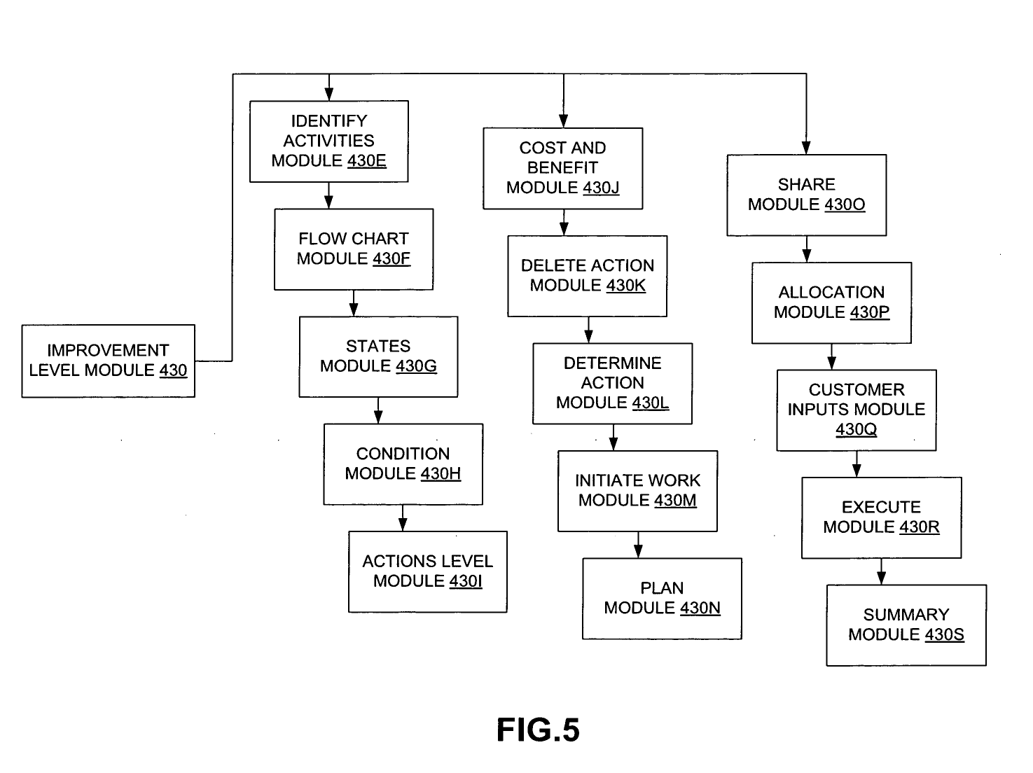

FIG. 5 illustrates additional modules associated with the improvement level module 430 of FIG. 4, according to one embodiment. Particularly, FIG. 5 illustrates an identify activities module 430E, a flow chart module 430F, a states module 430G, a conditions module 430H, an action list module 430I, a cost and benefit module 430J, a delete action module 430K, a determine action module 430L, an initiate work module 430M, a plan module 430N, a share module 430O, an allocation module 430P, a customer inputs module 430Q, and execute module 430R and a summary module 430S, according to one embodiment.

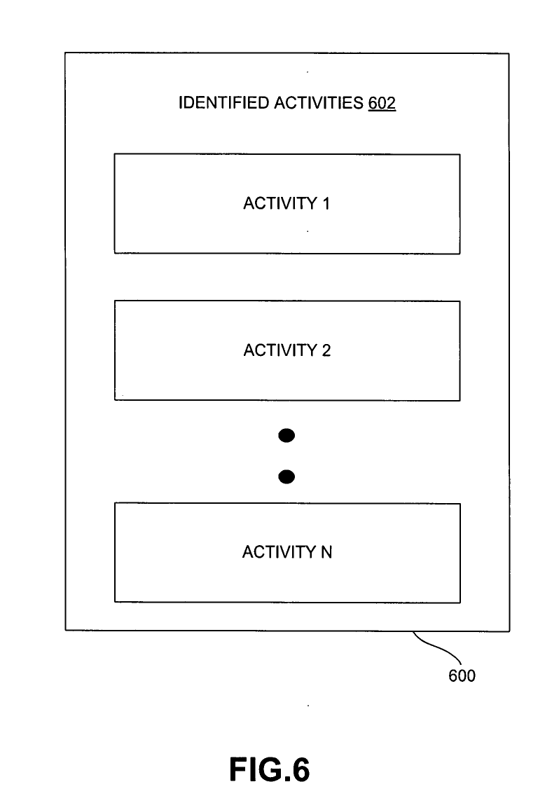

The identify activities module 430E may identify the activities that have a potential to significantly improve the customer's experience. The flow chart module 430F may generate a list of the identified activities 602 as a simplified flow chart (e.g., the simplified flow chart 600 of FIG. 6). The states module 430G may list measurements that describe current states 702 and project-improved states 704 for each identified activity 602 of the simplified flow chart 600. The conditions module 430H may generate a list of conditions associated with each current state 702 and each project-improved state 704.

The action list module 430I may generate a list of actions including starting, modifying, and/or stopping to bring about a project-improved state 704 from a current state 702. The cost and benefit module 430J may determine if an associated cost for each action significantly exceeds an associated benefit. The delete action module 430K may delete the action from the list of actions upon the determination that the associated cost significantly exceeds the associated benefit. The determine action module 430L may determine for each action, if the action is one selected from the group including essentially of simple and complex.

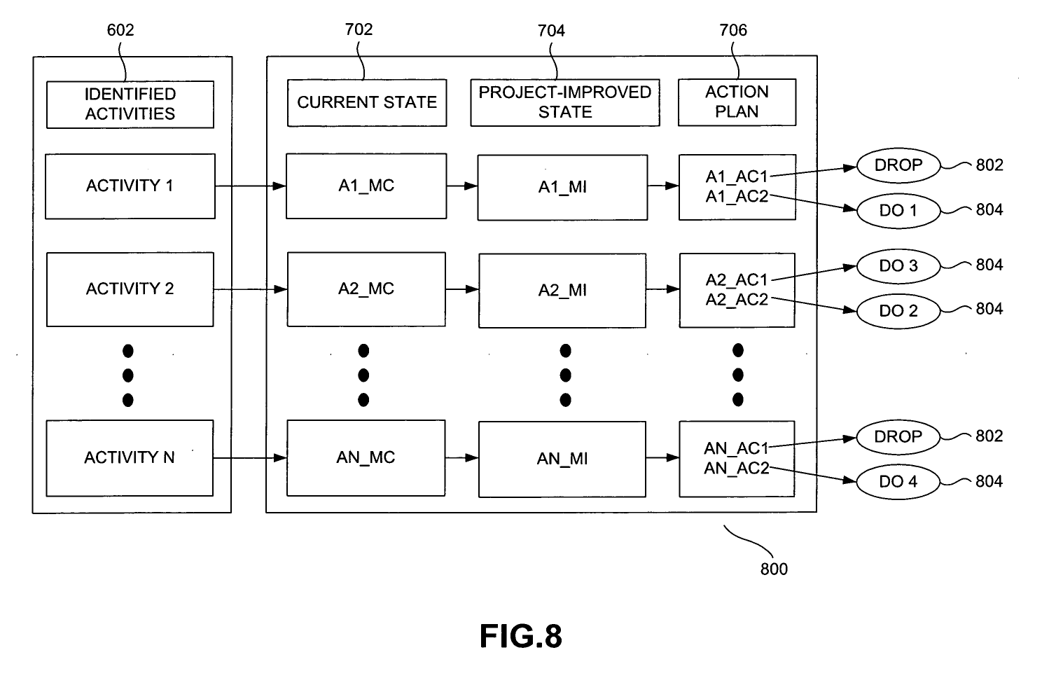

The initiate work module 430M may initiate work associated with the action upon a determination that the action is simple. The plan module 430N may prioritize the action and generate a timebound plan (e.g., the timebound plan 800 of FIG. 8) to successfully execute the action. The share module 430O may share the simplified flow chart and the timebound plan 800. For example, sharing the activities may make concerned people aware of the timelines and priorities. The allocation module 430P may generate an allocation of time associated with the timebound plan 800. For example, the allocation may be necessary to meet the deliverables using critical resources and certain deadlines. The customer inputs module 430Q may request customer inputs associated with the timebound plan 800. The execute plan module 430R may execute the timebound plan 800. The summary module 430S may share a summary of the execution of the timebound plan 800. For example, sharing the summary of the plan may initiate the development of the relationship with the customer.

FIG. 6 illustrates a simplified flow chart 600 representing a list of identified activities 602 associated with the customer service, according to one embodiment. In one embodiment, activity 1, activity 2 and activity N illustrated in FIG. 6 are identified as potential activities that can significantly improve a customer's experience. Further, the identified activities 602 (e.g., activity 1, activity 2 and activity N) are listed out in the simplified flow chart 600.

For example, consider requirements gathering, designing new modules, coding to resolve bugs, conducting code reviews, etc. as activities that are identified as potential activities (i.e. activities that can significantly improve a software design customer's experience). Further, these activities can be listed out in the simplified flow chart 600 with requirements gathering as activity 1, designing new modules as activity 2, coding to resolve bugs as activity N and conducting code reviews as activity 4.

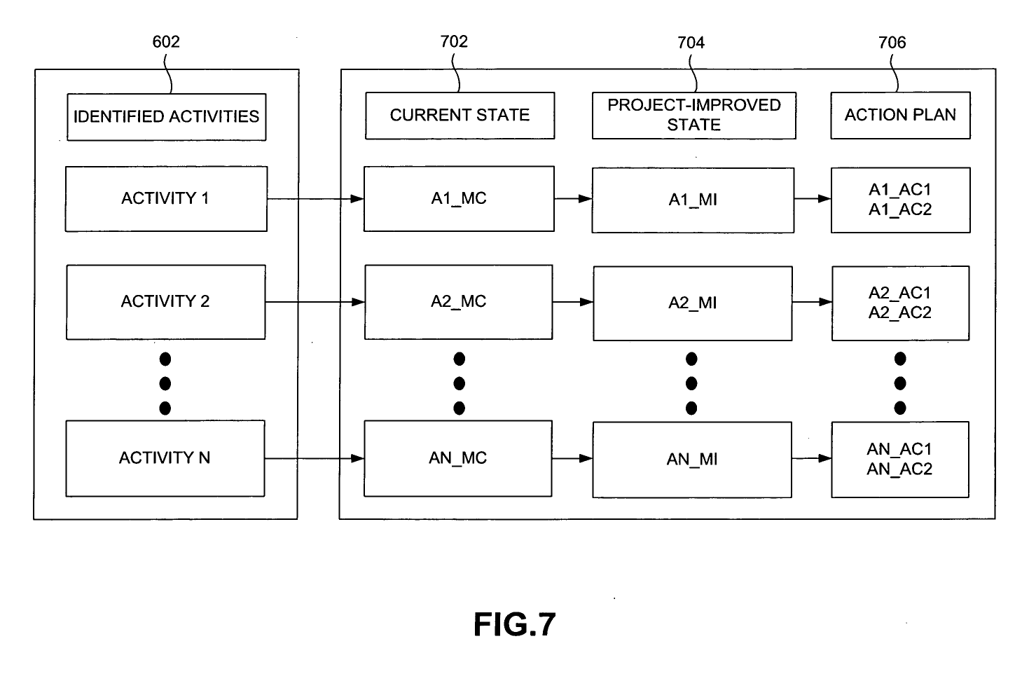

FIG. 7 is a block diagram illustrating a list of measurements that describe current states 702 and project-improved states 704 of each identified activity 602, according to one embodiment. The current state 702 may indicate a present position of the identified activity 602. The project-improved state 704 may indicate an enhanced status of the activity that may be implemented to improve the customer experience. In some embodiments, the activities that have a potential to significantly improve a customer's experience are identified and a list of the identified activities 602 are generated as a simplified flow chart 600.

For each identified activity 602 of the simplified flow chart 600, a list of measurements that describe current states 702 and project-improved states 704 is generated. Further, for each current state 702 and each project-improved state 704, a list of conditions associated with the state is generated. In these embodiments, a list of actions including starting, modifying, and/or stopping is generated for each condition associated with the state to bring about a project-improved state 704 from the current state 702.

FIG. 8 is a block diagram illustrating a timebound action plan associated with the identified activities 602, according to one embodiment. For example, the identified activities 602 with the action plan 706 in the simplified flow chart 600 are illustrated in FIG. 8. In some embodiments, it is determined if associated cost for each action significantly exceeds an associated benefit. In these embodiments, actions are deleted upon a determination that an associated cost significantly exceeds an associated benefit. Further, it is determined if each action is selected from the group including essentially of simple and complex.

In these embodiments, work associated with the action is initiated upon a determination that the action is simple, otherwise the action is prioritized and the timebound plan 800 is generated to successfully execute the action. Finally, the simplified flow chart and the timebound plan 800 are shared to generate an allocation of time associated with the timebound plan 800. In addition, customer inputs associated with the timebound plan 800 is requested and the timebound plan 800 is executed. In some embodiments, a summary of the execution of the timebound plan 800 is shared with the customer.

In the example embodiment illustrated in FIG. 8, the actions, A1_AC1 and A3-AC1 are deleted from an action plan 706 (e.g., the deleted actions A1_AC1 and AN_AC1 are illustrated in the FIG. 8 as DROP 802) due to significant high cost with respect to associated benefit whereas the actions, A1_AC2, A2_AC2, A2_AC1, and AN_AC2 are prioritized as DO 1 804, DO 2 804, DO 3 804, and DO 4 804 respectively prior to generating timebound plan 800.

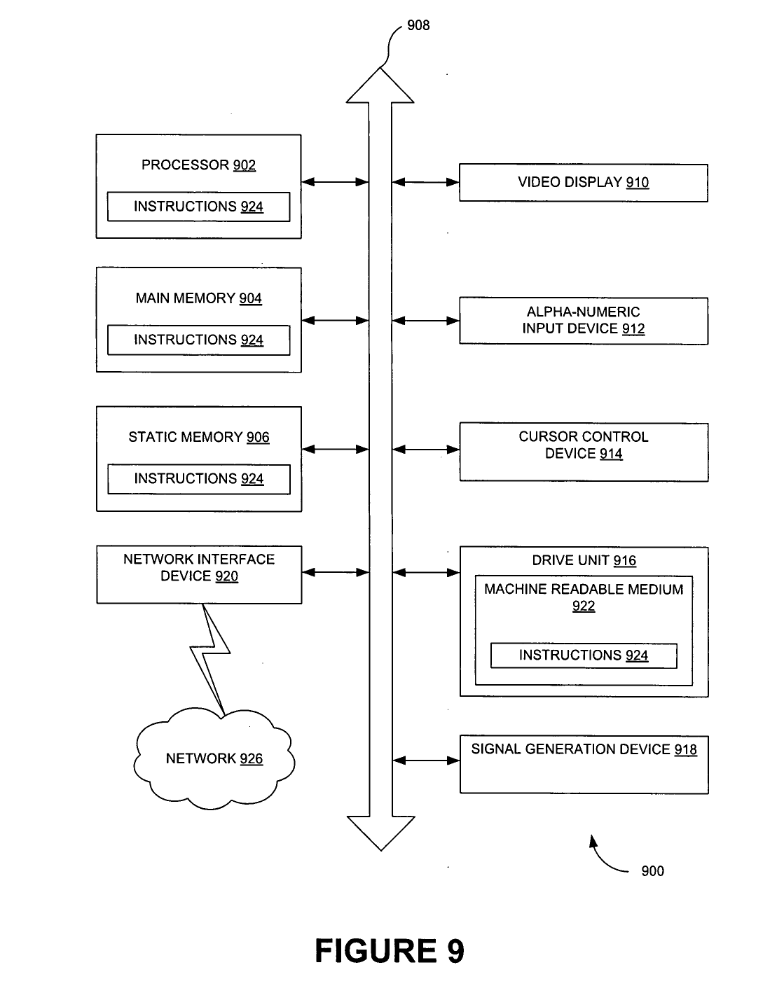

FIG. 9 is a diagrammatic system view 900 of a data processing system in which any of the embodiments disclosed herein may be performed, according to one embodiment. Particularly, the diagrammatic system view of FIG. 9 illustrates a processor 902, a main memory 904, a static memory 906, a bus 908, a video display 910, an alpha-numeric input device 912, a cursor control device 914, a drive unit 916, a signal generation device 918, a network interface device 920, a machine readable medium 922, instructions 924 and a network 926, according to one embodiment.

The diagrammatic system view 900 may indicate a personal computer and/or a data processing system in which one or more operations disclosed herein are performed. The processor 902 may be a microprocessor, a state machine, an application specific integrated circuit, a field programmable gate array, etc. The main memory 904 may be a dynamic random access memory and/or a primary memory of a computer system. The static memory 906 may be a hard drive, a flash drive, and/or other memory information associated with the data processing system.

The bus 908 may be an interconnection between various circuits and/or structures of the data processing system. The video display 910 may provide graphical representation of information on the data processing system. The alpha-numeric input device 912 may be a keypad, keyboard and/or any other input device of text (e.g., a special device to aid the physically handicapped). The cursor control device 914 may be a pointing device such as a mouse. The drive unit 916 may be a hard drive, a storage system, and/or other longer term storage subsystem. The signal generation device 918 may be a bios and/or a functional operating system of the data processing system.

The network interface device 920 may perform interface functions (e.g., code conversion, protocol conversion, and/or buffering) required for communications to and from the network 926 between a number of independent devices (e.g., of varying protocols). The machine readable medium 922 may provide instructions on which any of the methods disclosed herein may be performed. The instructions 924 may provide source code and/or data code to the processor 902 to enable any one or more operations disclosed herein.

For example, a customer service environment 100 includes a first instruction set to enable a customer service network 110, to include a customer service database 220 associated with demand records 210, each demand record 210 associated with a particular customer service level of a customer service hierarchy and a second instruction set integrated with the first instruction set to determine if the demands of an initial customer service level (e.g., the implementation level 120 of FIG. 1) in the customer service hierarchy are met. The customer service environment 100 also includes a third instruction set integrated with the first instruction set and the second instruction set to determine if the demands of the initial customer service level are exceeded upon a determination that the demands of the initial customer service level are met.

Further, a fourth instruction set of the customer service environment 100 integrated with the first instruction set, the second instruction set, the third instruction set, for each successor customer service level in the customer service hierarchy, determines if the demands of a predecessor customer service level in the customer service hierarchy continue to be exceeded, determines if the demands of a successor customer service level in the customer service hierarchy are met upon a determination that the demands of the predecessor customer service level continue to be exceeded, and ensures that the demands of the successor customer service level in the customer service hierarchy are exceeded upon a determination that the demands of the successor customer service level are met.

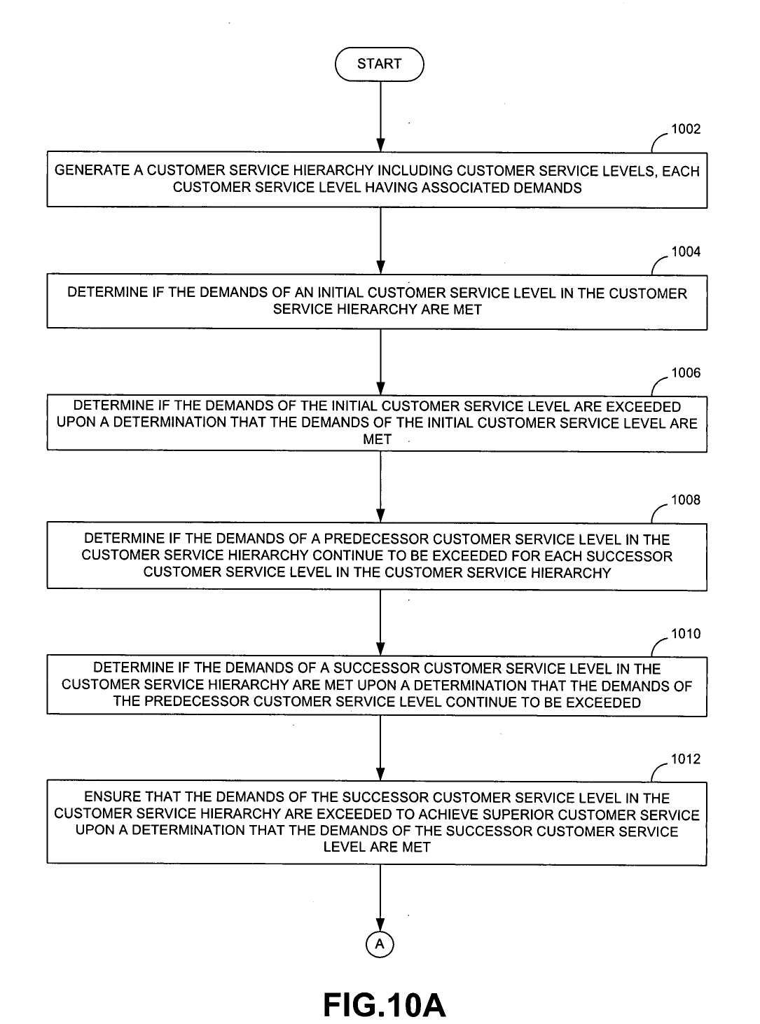

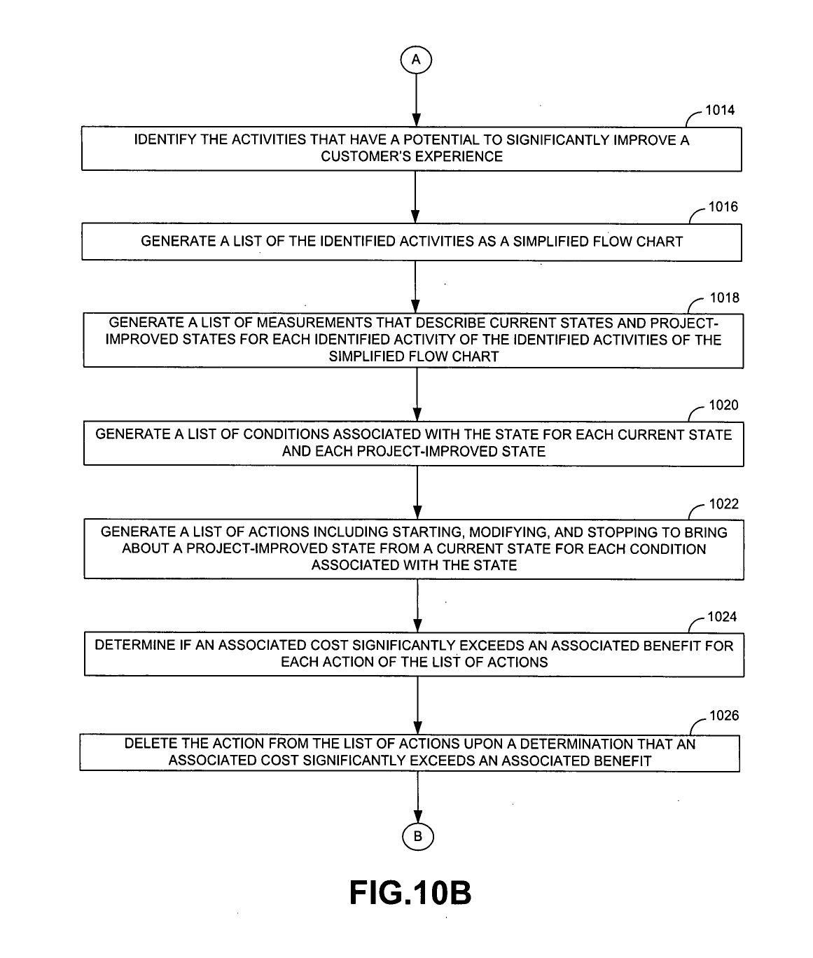

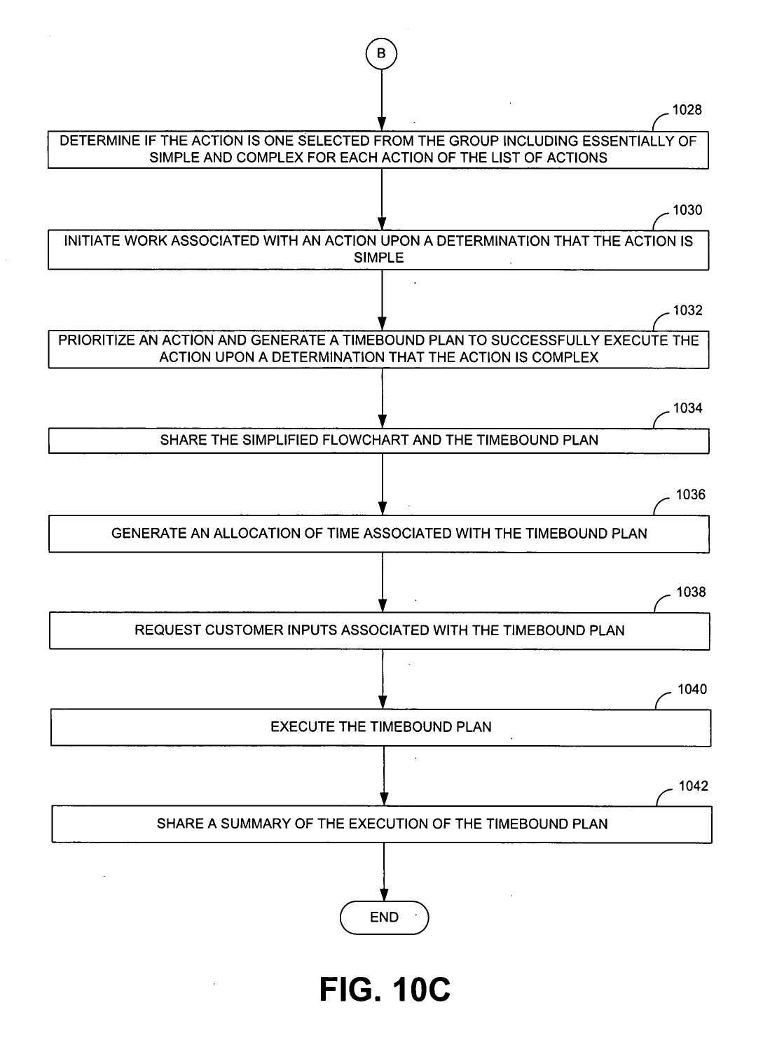

FIG. 10A is a process flow of generating a customer service hierarchy to achieve customer service excellence, according to one embodiment. In operation 1002, the customer service hierarchy including customer service levels may be generated (e.g., the implementation level 120, the improvement level 130 and the innovation level 140 of FIG. 1) (e.g., using the customer service module 310 of FIG. 3), each customer service level having associated demands. In operation 1004, it may be determined (e.g., using the initial meet demand module 320 of FIG. 3) if the demands of an initial customer service level (e.g., the implementation level 120 of FIG. 1) in the customer service hierarchy are met.

In operation 1006, it may be determined (e.g., using the initial exceed demand module 330 of FIG. 3) if the demands of the initial customer service level 120 are exceeded upon a determination that the demands of the initial customer service level 120 are met. In operation 1008, for each successor customer service level (e.g., the improvement level 130 and the innovation level 140 of FIG. 1) in the customer service hierarchy, it may be determined (e.g., using the predecessor exceed module 340 of FIG. 3) if the demands of a predecessor customer service level (e.g., the implementation level 120 of FIG. 1) in the customer service hierarchy continue to be exceeded.

In operation 1010, it may be determined (e.g., using the successor meet demand module 350 of FIG. 3) if the demands of a successor customer service level (e.g., the improvement level 130 of FIG. 1) in the customer service hierarchy are met upon a determination that the demands of the predecessor customer service level 120 continue to be exceeded. In operation 1012, it may be ensured (e.g., using the successor exceed demand module 360 of FIG. 3) that the demands of the successor customer service level 130 in the customer service hierarchy are exceeded to achieve superior customer service upon a determination that the demands of the successor customer service level 130 are met.

FIG. 10B is a continuation of the process flow of FIG. 10A, illustrating additional processes, according to one embodiment. In operation 1014, the activities that have a potential to significantly improve a customer's experience may be identified (e.g., using the identify activities module 430E of FIG. 5). In operation 1016, a list of the identified activities 602 may be generated (e.g., using the flow chart module 430F of FIG. 5) as a simplified flow chart 600. In operation 1018, a list of measurements that describe current states 702 and project-improved states 704 may be generated (e.g., using the states module 430G of FIG. 5) for each identified activity 602 of the simplified flow chart 600. In operation 1020, a list of conditions associated with the state may be generated (e.g., using the conditions module 430H of FIG. 5) for each current state 702 and each project-improved state 704.

In operation 1022, a list of actions including starting, modifying, and/or stopping may be generated (e.g., using the action list module 430I of FIG. 5) for each condition associated with the state to bring about a project-improved state 704 from a current state 702. In operation 1024, it may be determined (e.g., using the cost and benefit module 430J of FIG. 5) if an associated cost significantly exceeds an associated benefit for each action of the list of actions. In operation 1026, the action may be deleted (e.g., using the delete action module 430K of FIG. 5) from the list of actions upon a determination that an associated cost significantly exceeds an associated benefit.

FIG. 10C is a continuation of the process flow of FIG. 10B, illustrating additional processes, according to one embodiment. In operation 1028, it may be determined for each action (e.g., using the determine action module 430L of FIG. 5) if the action is one selected from the group including essentially of simple and complex. In operation 1030, work associated with an action may be initiated (e.g., using the initiate work module 430M of FIG. 5) upon a determination that the action is simple. In operation 1032, an action may be prioritized and a timebound plan 800 may be generated (e.g., using the plan module 430N of FIG. 5) to successfully execute the action upon a determination that the action is complex.

In operation 1034, the simplified flow chart 600 and the timebound plan 800 may be shared (e.g., using the share module 430O of FIG. 5). In operation 1036, an allocation of time associated with the timebound plan 800 may be generated (e.g., using the allocation module 430P of FIG. 5). In operation 1038, customer inputs associated with the timebound plan 800 may be requested (e.g., using the customer inputs module 430Q of FIG. 5). In operation 1040, the timebound plan 800 may be executed (e.g., using the execute plan module 430R of FIG. 5). In operation 1042, a summary of the execution of the timebound plan 800 may be shared (e.g., using the summary module 430S of FIG. 5).

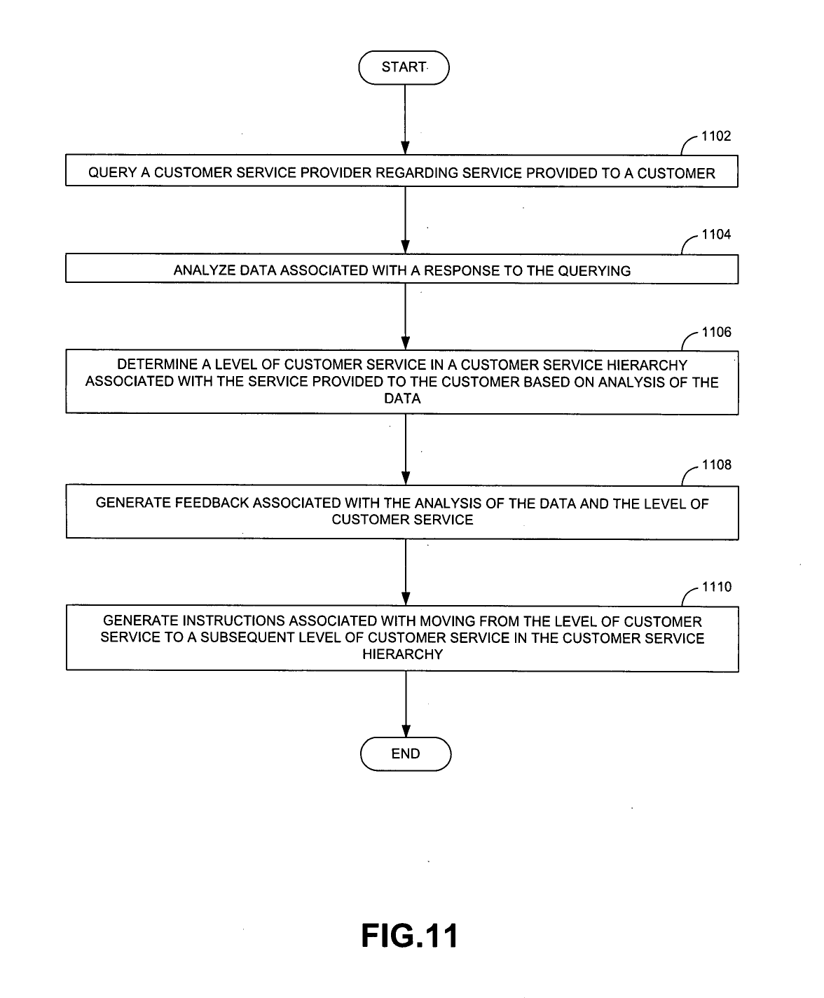

FIG. 11 is a process flow of determining a level of customer service associated with a service of a customer, according to one embodiment. In operation 1102, a customer service provider may be queried regarding the service provided to the customer. In operation 1104, data associated with a response to the querying may be analyzed.

In operation 1106, a level of customer service in a customer service hierarchy associated with the service provided to the customer may be determined based on analysis of the data. In operation 1108, feedback associated with the analysis of the data and the level of customer service may be generated. In operation 1110, instructions associated with moving from the level of customer service to a subsequent level of customer service in the customer service hierarchy may be generated.

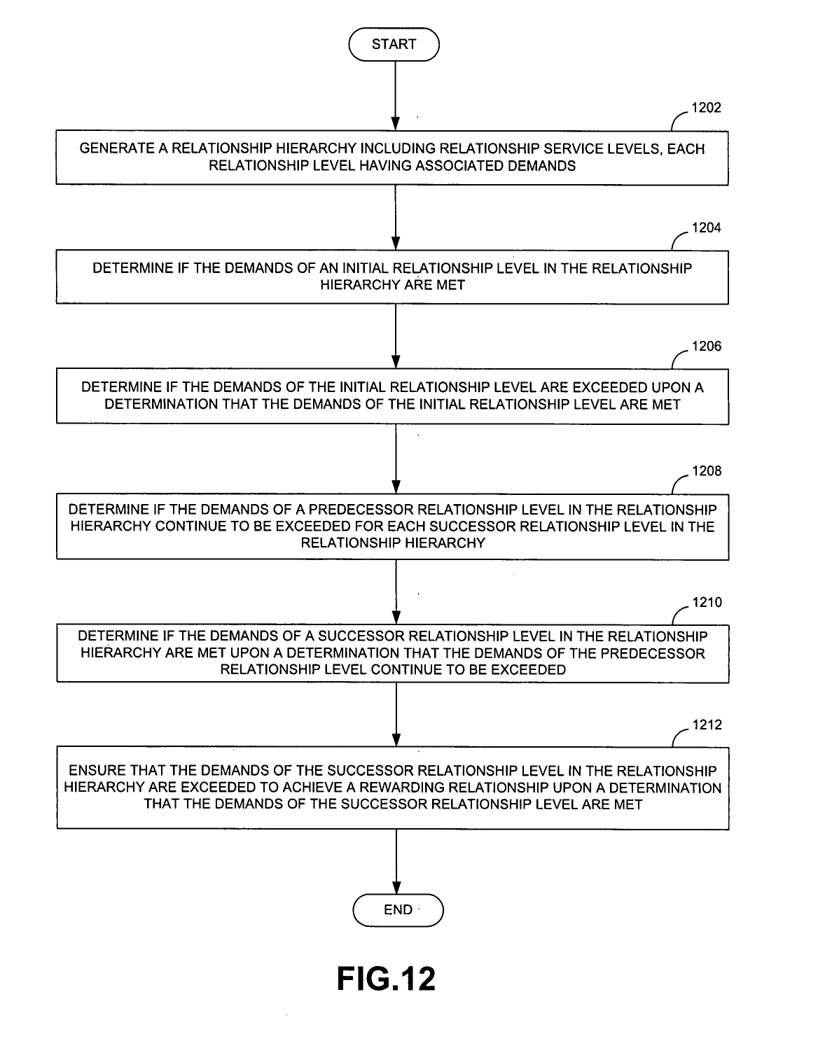

FIG. 12 is a process flow of generating a relationship hierarchy to achieve a rewarding relationship, according to one embodiment. In operation 1202, the relationship hierarchy including relationship levels may be generated (e.g., the implementation level, the improvement level and the innovation level), each relationship level having associated demands. In operation 1204, it may be determined if the demands of an initial relationship level (e.g., the implementation level) in the relationship hierarchy are met.

In operation 1206, it may be determined if the demands of the initial relationship level are exceeded upon a determination that the demands of the initial relationship level are met. In operation 1208, for each successor relationship level (e.g., the improvement level and the innovation level) in the relationship hierarchy, it may be determined if the demands of a predecessor relationship level (e.g., the implementation level) in the relationship hierarchy continue to be exceeded.

In operation 1210, it may be determined if the demands of a successor relationship level (e.g., the improvement level) in the relationship hierarchy are met upon a determination that the demands of the predecessor relationship level continue to be exceeded. In operation 1212, it may be ensured that the demands of the successor relationship level in the relationship hierarchy are exceeded to achieve a rewarding relationship upon a determination that the demands of the successor relationship level are met.

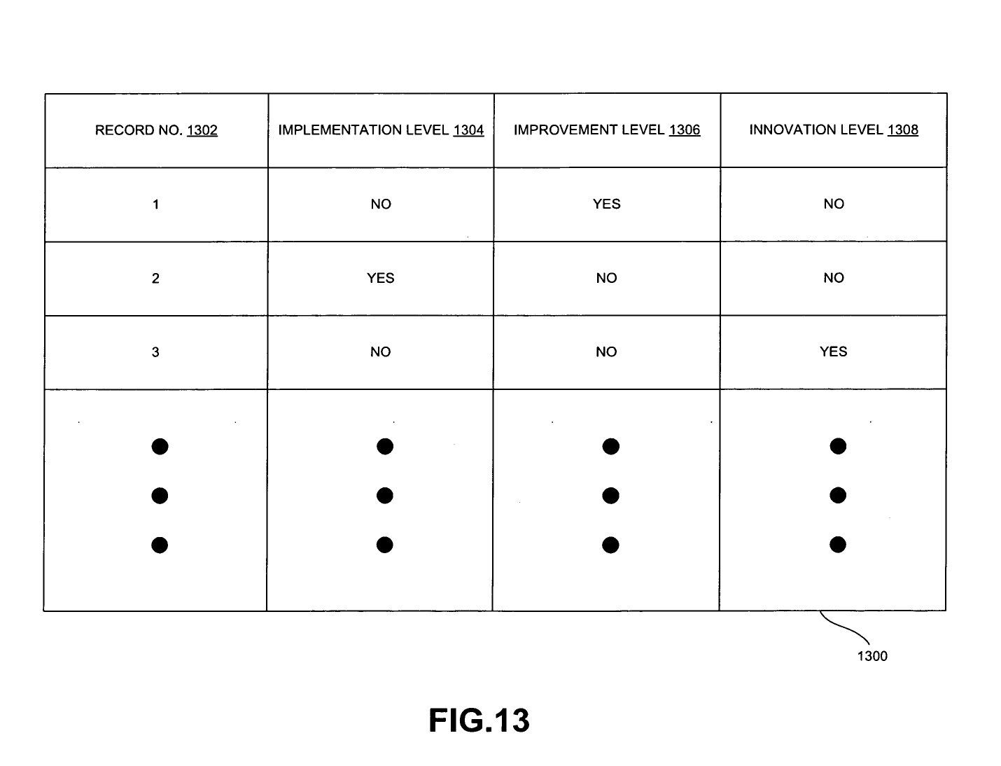

FIG. 13 is a table view illustrating demand to be met at various customer service levels in the customer service hierarchy, according to one embodiment. Particularly, FIG. 13 illustrates a record number field 1302, an implementation level field 1304, an improvement level field 1306 and an innovation level field 1308, according to one embodiment.

The record number field 1302 may indicate various demands of customers that are recorded and need to be met at various levels of the customer service. The implementation level field 1304 may indicate whether or not a particular demand of the customer is to be met at the initial level (e.g., the implementation level 120 of FIG. 1). The improvement level field 1306 may indicate whether or not a particular demand of the customer is to be met at the improvement level 130. The innovation level field 1308 may indicate whether or not a particular demand of the customer is to be met at the innovation level 140 of FIG. 1).

In the example embodiment illustrated in FIG. 13, the record number field 1302 indicates ‘1’ in the first row, ‘2’ in the second row and ‘3’ in the third row of the record number field column 1302 indicating the demand records 1, 2 and 3 respectively. The implementation level field 1304 indicate ‘No’ in the first row, ‘Yes’ in the second row and ‘No’ in the third row of the implementation level field column 1306 (e.g., at the implementation level 120, the demand record 1 is to be met).

The improvement level field 1306 indicates ‘Yes’ in the first row, ‘No’ in the second row, and ‘No’ in the third row of the improvement level field column 1306 (e.g., (e.g., at the improvement level 130, the demand record 2 is to be met). The innovation level field 1308 indicates ‘No’ in the first row, ‘No’ in the second row and ‘Yes’ in the third row of the innovation level field column 1308 (e.g., at the innovation level 140, the demand record 3 is to be met).

The above-described method illustrates three levels of customer service, what it takes to meet demands of each level, and how to scale up to the next level(s) thus facilitating delivery of superior customer service in today's complex business scenarios characterized by hectic work schedules. Further, the above-described method deals with “mindset” required for different levels of customer service. In one embodiment, the above-described framework categorizes a customer service into three distinct levels, and articulates details of the characteristics and competencies required to meet and excel at each level. In addition, the framework deals with “Service Mindset” rather than usage of specific processes, tools or techniques thus does not require creation of process and/or other overloads that demand dedicated time and effort. With this framework, users working in service intensive roles can access their current level of customer service, how to better the same and how to move up the next levels of service.

Also, the above described method may be in a form of a machine-readable medium embodying a set of instructions that, when executed by a machine, causes the machine to perform any method disclosed herein. It will be appreciated that the various embodiments discussed herein may not be the same embodiment, and may be grouped into various other embodiments not explicitly disclosed therein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
generating a customer service hierarchy including customer service levels, each customer service level having associated demands;
determining if the demands of an initial customer service level in the customer service hierarchy are met;
upon a determination that the demands of the initial customer service level are met, determining if the demands of the initial customer service level are exceeded; and
for each successor customer service level in the customer service hierarchy, determining if the demands of a predecessor customer service level in the customer service hierarchy continue to be exceeded;
upon a determination that the demands of the predecessor customer service level continue to be exceeded, determining if the demands of a successor customer service level in the customer service hierarchy are met; and
upon a determination that the demands of the successor customer service level are met, ensuring that the demands of the successor customer service level in the customer service hierarchy are exceeded to achieve superior customer service.

2. The method of claim 1, wherein the customer service levels of the customer service hierarchy comprise:
an implementation level to implement customer service;
an improvement level to improve upon a customer experience; and
an innovation level to achieve superior customer service.

3. The method of claim 2, wherein the implementation level includes at least one skill selected from the group consisting essentially of listening skills, hard work, attention to detail, and reliability.

4. The method of claim 2, wherein the implementation level comprises:
generating a list of at least one experience associated with a moment of truth;
for each experience associated with a moment of truth, identifying at least one potential negative perception;
for each potential negative perception, generate a list of measures to be adopted to convert the at least one potential negative perception into a potential positive perception.

5. The method of claim 2, wherein the improvement level includes at least one skill selected from the group consisting essentially of zero tolerance to mediocrity, positive restlessness, a desire to make things better, and sensitivity.

6. The method of claim 2, wherein the improvement level comprises:
identifying key activities that have potential to significantly improve a customer's experience;
for each key activity of the key activities, examining a value proposition;
for each value proposition associated with a key activity of the key activities, evaluating options; and
based on the evaluated options associated with the key activity, executing at least one action.

7. The method of claim 6, further comprising:
identifying the activities that have a potential to significantly improve a customer's experience;
generating a list of the identified activities as a simplified flow chart;
for each identified activity of the identified activities of the simplified flow chart, generating a list of measurements that describe current states and project-improved states;
for each current state of the current states and each project-improved state of the project-improved states, generating a list of conditions associated with the state;
for each condition associated with the state, generating a list of actions comprising at least one of starting, modifying, and stopping to bring about a project-improved state from a current state;
for each action of the list of actions, determining if an associated cost significantly exceeds an associated benefit;
upon a determination that an associated cost significantly exceeds an associated benefit, deleting the action from the list of actions;
for each action of the list of actions, determining if the action is one selected from the group consisting essentially of simple and complex;
upon a determination that an action is simple, initiating work associated with the action;
upon a determination that an action is complex, prioritizing the action and generating a timebound plan to successfully execute the action;
sharing the simplified flow chart and the timebound plan;
generating an allocation of time associated with the timebound plan;
requesting customer inputs associated with the timebound plan;
executing the timebound plan; and
sharing a summary of the execution of the timebound plan.

8. The method of claim 2, wherein the innovation level includes at least one skill selected from the group consisting essentially of sustained passion, conviction, creative thinking, lateral thinking, collaborative spirit, and a spirit of superior service.

9. The method of claim 2, wherein the innovation level comprises:
creating visibility associated with the customer service;
practicing innovation in the customer service; and
building a relationship with a customer associated with the customer service.

10. The method of claim 1 in a form of a machine-readable medium embodying a set of instructions that, when executed by a machine, causes the machine to perform the method of claim 1.

11. A system, comprising:
a customer service module to generate a customer service hierarchy including customer service levels, each customer service level having associated demands;
an initial meet demand module to determine if the demands of an initial customer service level in the customer service hierarchy are met;
an initial exceed demand module to, upon a determination that the demands of the initial customer service level are met, determine if the demands of the initial customer service level are exceeded; and
a predecessor exceed demand module to, for each successor customer service level in the customer service hierarchy, determine if the demands of a predecessor customer service level in the customer service hierarchy continue to be exceeded;
a successor meet demand module to, upon a determination that the demands of the predecessor customer service level continue to be exceeded, determine if the demands of a successor customer service level in the customer service hierarchy are met; and
a successor exceed demand module to, upon a determination that the demands of the successor customer service level are met, ensure that the demands of the successor customer service level in the customer service hierarchy are exceeded to provide superior customer service.

12. The system of claim 11, wherein the customer service module of the customer service hierarchy comprises:
a customer service hierarchy module to generate customer service levels comprising:
an implementation level module to generate an implementation level to implement customer service;
an improvement level module to generate an improvement level to improve upon a customer experience; and
an innovation level module to generate an innovation level to achieve superior customer service.

13. The system of claim 12, wherein the implementation level includes at least one skill selected from the group consisting essentially of listening skills, hard work, attention to detail, and reliability.

14. The system of claim 12, wherein the implementation level module comprises:
a moment of truth module to generate a list of at least one experience associated with a moment of truth;
an identify negative potential module to identify, for each experience, at least one potential negative perception;
an adopt measure module to, for each potential negative perception, generate a list of measures to be adopted to convert the potential negative perception into a potential positive perception.

15. The system of claim 12, wherein the improvement level includes at least one skill selected from the group consisting essentially of zero tolerance to mediocrity, positive restlessness, a desire to make things better, and sensitivity.

16. The system of claim 12, wherein the improvement level module comprises:
a key activities module to identify key activities that have potential to significantly improve a customer's experience;
a value proposition module to, for each key activity of the key activities, examine a value proposition;
an evaluate options module to, for each value proposition associated with a key activity of the key activities, evaluate options; and
an execute action module to, based on the evaluated options associated with the key activity, execute at least one action.

17. The system of claim 16, wherein the improvement level module further comprises:
an identify activities module to identify the activities that have a potential to significantly improve a customer's experience;
a flow chart module to generate a list of the identified activities as a simplified flow chart;
a states module to, for each identified activity of the identified activities of the simplified flow chart, list measurements that describe current states and project-improved states;
a conditions module to, for each current state of the current states and each project-improved state of the project-improved states, generate a list of conditions associated with the state;
an action list module to, for each condition associated with the state, generate a list of actions comprising at least one of starting, modifying, and stopping to bring about a project-improved state from a current state;
a cost and benefit module to, for each action of the list of actions, determine if an associated cost significantly exceeds an associated benefit;
a delete action module to, upon a determination that an associated cost significantly exceeds an associated benefit, delete the action from the list of actions;
a determine action module to, for each action of the list of actions, determine if the action is one selected from the group consisting essentially of simple and complex;
an initiate work module to, upon a determination that an action is simple, initiate work associated with the action;
a plan module to, upon a determination that an action is complex, prioritize the action and generate a timebound plan to successfully execute the action;
a share module to share the simplified flow chart and the timebound plan;
an allocation module to generate an allocation of time associated with the timebound plan;
a customer inputs module to request customer inputs associated with the timebound plan;
an execute plan module to execute the timebound plan; and
a summary module to share a summary of the execution of the timebound plan.

18. The system of claim 12, wherein the innovation level includes at least one skill selected from the group consisting essentially of sustained passion, conviction, creative thinking, lateral thinking, collaborative spirit, and a spirit of superior service.

19. The system of claim 12, wherein the innovation level module comprises:
a visibility module to create visibility associated with the customer service;
a practice module to practice innovation in the customer service; and
a relationship module to build a relationship with a customer associated with the customer service.

20. A customer service environment, comprising:
a first instruction set to enable a customer service network, to include a customer service database associated with demand records, each demand record of the demand records associated with a particular customer service level of a customer service hierarchy;
a second instruction set integrated with the first instruction set to determine if the demands of an initial customer service level in the customer service hierarchy are met;
a third instruction set integrated with the first instruction set and the second instruction set to, upon a determination that the demands of the initial customer service level are met, determine if the demands of the initial customer service level are exceeded; and
a fourth instruction set integrated with the first instruction set, and the second instruction set, the third instruction set to, for each successor customer service level in the customer service hierarchy:
determine if the demands of a predecessor customer service level in the customer service hierarchy continue to be exceeded;
upon a determination that the demands of the predecessor customer service level continue to be exceeded, determine if the demands of a successor customer service level in the customer service hierarchy are met; and
upon a determination that the demands of the successor customer service level are met, ensure that the demands of the successor customer service level in the customer service hierarchy are exceeded.

21. A method, comprising:
querying a customer service provider regarding service provided to a customer;
analyzing data associated with a response to the querying; and
based on analysis of the data, determining a level of customer service in a customer service hierarchy associated with the service provided to the customer.

22. The method of claim 21, further comprising generating feedback associated with at least one of the analysis of the data and the level of customer service.

23. The method of claim 21, further comprising generating instructions associated with moving from the level of customer service in the customer service hierarchy to a subsequent level of customer service in the customer service hierarchy.

24. A method, comprising:
generating a relationship hierarchy including relationship levels, each relationship level having associated demands;
determining if the demands of an initial relationship level in the relationship hierarchy are met;
upon a determination that the demands of the initial relationship level are met, determining if the demands of the initial relationship level are exceeded; and
for each successor relationship level in the relationship hierarchy, determining if the demands of a predecessor relationship level in the relationship hierarchy continue to be exceeded;
upon a determination that the demands of the predecessor relationship level continue to be exceeded, determining if the demands of a successor relationship level in the relationship hierarchy are met; and
upon a determination that the demands of the successor relationship level are met, ensuring that the demands of the successor relationship level in the relationship hierarchy are exceeded to achieve a rewarding relationship.
